(19) United States
(12) Patent Application Publication
(10) Pub. No.: US 2025/0156867 A1
(43) Pub. Date: May 15, 2025

(54) INFORMATION MANAGEMENT APPARATUS

(71) Applicant: NEC Solution Innovations, Ltd., Koto-ku, Tokyo (JP)

(72) Inventor: Kazuhide UMEDA, Tokyo (JP)

(73) Assignee: NEC Solution Innovations, Ltd., Koto-ku, Tokyo (JP)

(21) Appl. No.: 18/832,992

(22) PCT Filed: Feb. 3, 2023
(86) PCT No.: PCT/JP2023/003604

§ 371 Date: Jul. 25, 2024

(30) Foreign Application Priority Data
Feb. 16, 2022 (JP) 2022-021793

(51) Int. Cl. G06Q 20/40

(52) U.S. Cl. CPC G06Q 20/40145

(57) ABSTRACT

An information management apparatus includes: an accepting unit that accepts from an external device a usage request that is a request for use of NFT (non-fungible token) biometric information associating biometric information corresponding to a characteristic of a person with a non-fungible token; and a transmitting unit that transmits based on the usage request accepted by the accepting unit the NFT biometric information and an attribute of the person managed in association with the NFT biometric information to a sender of the usage request.

### TECHNICAL FIELD

The present invention relates to an information management apparatus, an information management method, and a recording medium.

### BACKGROUND ART

Utilization of biometric information such as a face feature value to achieve various purposes including face recognition is known.

For example, Patent Literature 1 describes a face recognition apparatus that includes: a face image acquiring unit that acquires a face image of a recognition target; a matching unit that performs face recognition based on a threshold value on the face image of the recognition target; a time measuring unit that measures an elapsed time since the start of operation of the face recognition apparatus; and a threshold value changing unit that restricts the change of the threshold value to a value larger than a value determined depending on the measured elapsed time.

### CITATION LIST

### Patent Literature

Patent literature 1: Japanese Unexamined Patent Application Publication No. 2019-125003
Patent literature 2: Japanese Patent No. 6710401

### SUMMARY OF INVENTION

### Technical Problem

For performing face recognition as described in Patent Literature 1, it is required to register biometric information such as a face feature value for each service at the time of use of the service and the like. Therefore, there has been a problem that it takes time and effort to utilize biometric information.

Accordingly, an object of the present invention is to provide an information management apparatus, an information management method, and a program that solve the problem of difficulty of limiting time and effort required for utilization of biometric information.

### Solution to Problem

In order to achieve the object, an information management apparatus as an aspect of the present disclosure includes: an accepting unit that accepts from an external device a usage request that is a request for use of NFT (non-fungible token) biometric information associating biometric information corresponding to a characteristic of a person with a non-fungible token; and a transmitting unit that transmits based on the usage request accepted by the accepting unit the NFT biometric information and an attribute of the person managed in association with the NFT biometric information to a sender of the usage request.

Further, an information management method as another aspect of the present disclosure includes: accepting from an external device a usage request that is a request for use of NFT (non-fungible token) biometric information associating biometric information corresponding to a characteristic of a person with a non-fungible token; and transmitting based on the accepted usage request the NFT biometric information and an attribute of the person managed in association with the NFT biometric information to a sender of the usage request.

Further, a recording medium as another aspect of the present disclosure is a computer-readable recording medium with a program recorded, and the program is for realizing processes to: accept from an external device a usage request that is a request for use of NFT (non-fungible token) biometric information associating biometric information corresponding to a characteristic of a person with a non-fungible token; and transmit based on the accepted usage request the NFT biometric information and an attribute of the person managed in association with the NFT biometric information to a sender of the usage request.

### Advantageous Effects of Invention

According to the configurations as described above, it becomes possible to limit time and effort required for utilization of biometric information.

### BRIEF DESCRIPTION OF DRAWINGS

FIG. 1 is a view for describing an information management system in a first example embodiment of the present disclosure.

FIG. 2 is a block diagram showing an example of the configuration of an information management apparatus shown in FIG. 1.

FIG. 3 is a view showing an example of management information.

FIG. 4 is a view showing another example of the management information.

FIG. 5 is a block diagram showing an example of the configuration of a user device.

FIG. 6 is a flowchart showing an example of the operation of the information management apparatus at the time of registration.

FIG. 7 is a flowchart showing an example of the operation of the information management apparatus at the time of use.

FIG. 8 is a block diagram showing another example of the configuration of the information management apparatus.

FIG. 9 is a view showing another example of the configuration of the information management system.

FIG. 10 is a view showing an example of the hardware configuration of an information management apparatus in a second example embodiment of the present disclosure.

FIG. 11 is a block diagram showing an example of the configuration of the information management apparatus.

### DESCRIPTION OF EXAMPLE EMBODIMENTS

### First Example Embodiment

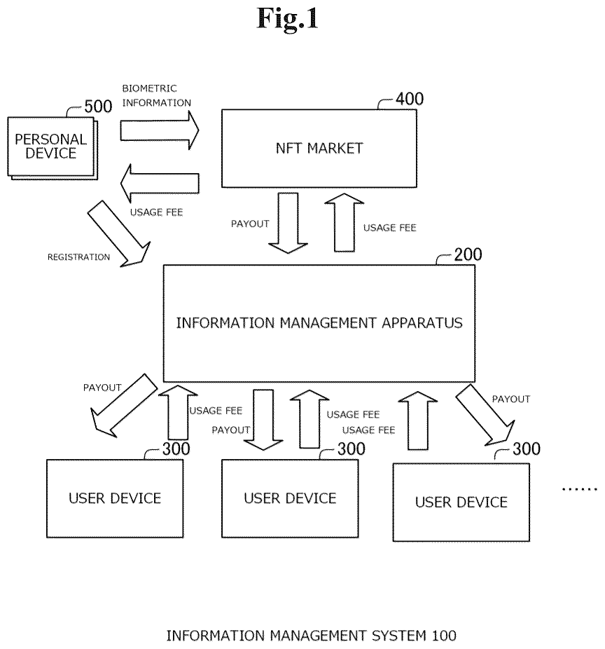

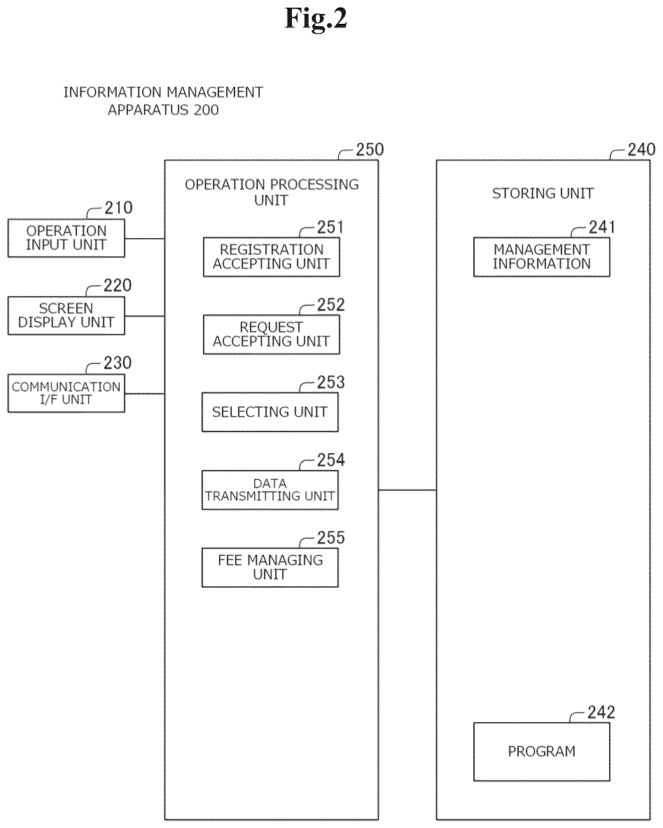

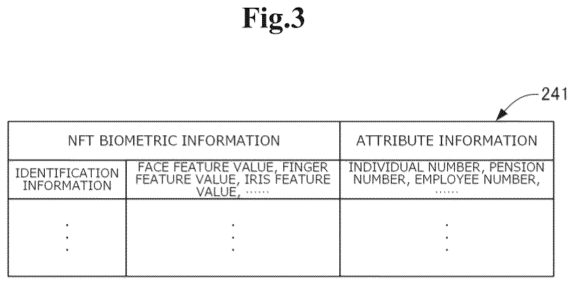

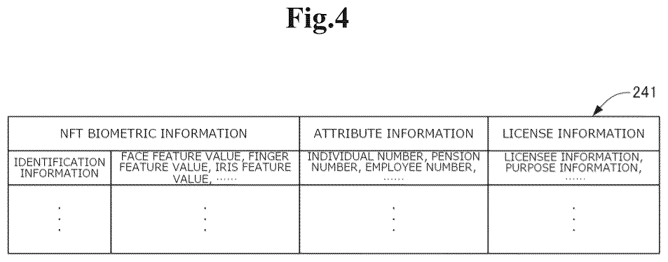

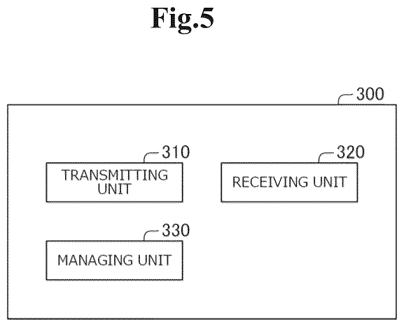

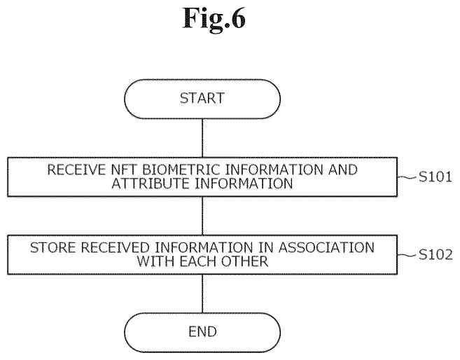

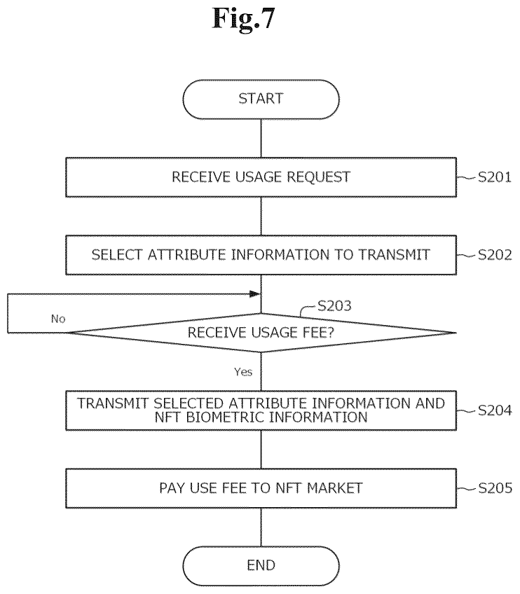

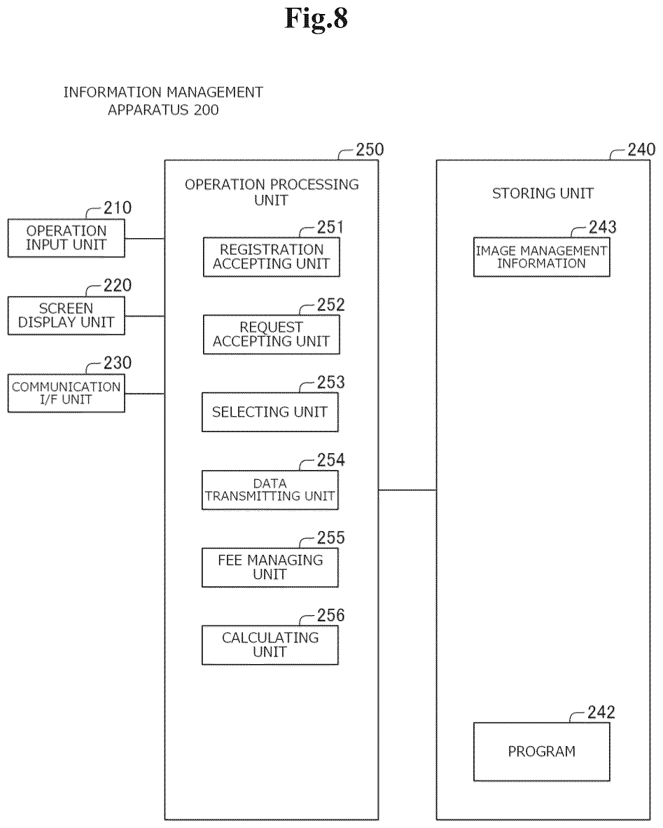

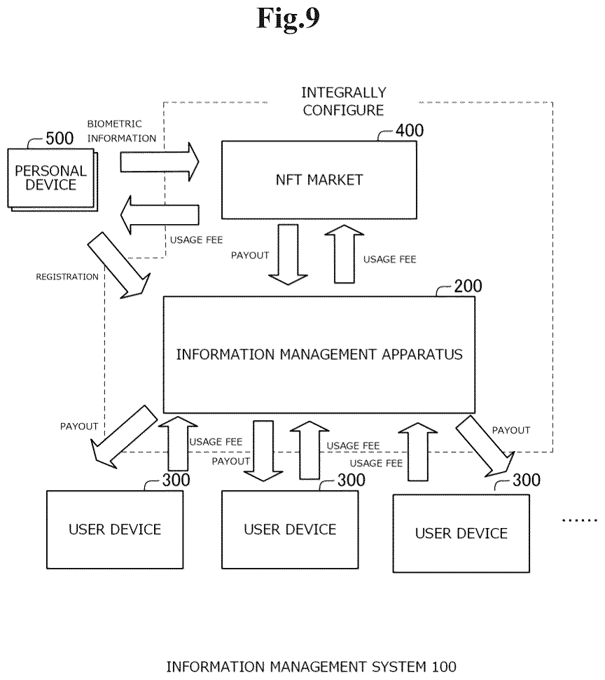

A first example embodiment of the present disclosure will be described with reference to FIGS. 1 to 9. FIG. 1 is a view for describing an information management system 100. FIG. 2 is a block diagram showing an example of the configuration of an information management apparatus 200. FIG. 3 is a view showing an example of management information 241. FIG. 4 is a view showing another example of the management information 241. FIG. 5 is a block diagram showing an example of the configuration of a user device 300. FIG. 6 is a flowchart showing an example of the operation of the information management apparatus 200 at the time of registration. FIG. 7 is a flowchart showing an example of the operation of the information management apparatus 200 at the time of use. FIG. 8 is a block diagram showing another example of the configuration of the information management apparatus 200. FIG. 9 is a view showing another example of the configuration of the information management system 100.

In the first example embodiment of the present disclosure, an information management system 100 that manages NFT (non-fungible token) biometric information associating any biometric information with an NFT will be described. As will be described later, the information management system 100 in this example embodiment stores NFT biometric information and attribute information including a plurality of attributes in association with each other. Moreover, when receiving a usage request that is a request for use of NFT biometric information from an external device, the information management system 100 selects an attribute to transmit in accordance with the sender of the usage request, or the like. After that, the information management system 100 transmits the selected attribute and the NFT biometric information to the sender of the usage request.

In this example embodiment, biometric information refers to information corresponding to the physical characteristics, behavioral characteristics and the like of a person. For example, biometric information can include at least one of a face feature value calculated based on a face image or the like of a person, a fingerprint feature value corresponding to minutiae or the like extracted from a finger image, an iris feature value corresponding to an iris pattern, a vein feature value corresponding to a vein pattern or the like of a palm or a finger, and so forth. Biometric information may include a feature value corresponding to behavioral characteristics such as a walking habit.

Further, NFT refers to a non-fungible token created and traded on a blockchain. For example, Patent Literature 2 describes NFT.

Further, attribute information includes a plurality of pieces of information indicating attributes of an individual or a group to which the individual belongs. Here, attributes in this example embodiment refer to, for example, identification information such as a number privately or publicly assigned to an individual or a group to which the individual belongs, such as individual number, pension number, employee number, credit card number, or various kinds of membership card numbers. Attributes may include information other than those illustrated above.

FIG. 1 shows an example of the configuration of the information management system 100. Referring to FIG. 1, the information management system 100 includes, for example, an information management apparatus 200, a user device 300, an NFT market 400, and a personal device 500. For example, as shown in FIG. 1, the information management system 100 includes a plurality of user devices 300 and a plurality of personal devices 500. The information management system 100 may include a plurality of information management apparatuses 200 and a plurality of NFT markets 400.

As shown in FIG. 1, the information management apparatus 200 and the user device 300 can be connected so as to be able to communicate with each other via any network or the like. Moreover, the information management apparatus 200 and the NFT market 400 can be connected so as to be able to communicate with each other via any network or the like. Moreover, the information management apparatus 200 and the personal device 500 can be connected so as to be able to communicate with each other via any network or the like. Moreover, the NFT market 400 and the personal device 500 can be connected so as to be able to communicate with each other via any network or the like.

The information management apparatus 200 is an information processing apparatus that manages NFT biometric information and attribute information in association with each other. FIG. 2 shows an example of the configuration of the information management apparatus 200. Referring to FIG. 2, the information management apparatus 200 includes, as main components, for example, an operation input unit 210, a screen display unit 220, a communication I/F unit 230, a storing unit 240, and an operation processing unit 250.

FIG. 2 illustrates a case of realizing a function as the information management apparatus 200 using a single information processing apparatus. However, the information management apparatus 200 may be realized using a plurality of information processing apparatuses, for example, may be realized on the cloud. For example, the information management apparatus 200 may be realized by a plurality of information processing apparatuses including part of the function illustrated in FIG. 2. Moreover, the information management apparatus 200 may exclude part of the configuration illustrated above, for example, without the operation input unit 210, and may have a configuration other than that illustrated above.

The operation input unit 210 includes operation input devices such as a keyboard and a mouse. The operation input unit 210 detects an operation by a person operating the information management apparatus 200 and outputs to the operation processing unit 250.

The screen display unit 220 includes a screen display device such as an LCD (Liquid Crystal Display). The screen display unit 220 can display on a screen a variety of information and so forth stored in the storing unit 240 in response to an instruction from the operation processing unit 250.

The communication I/F unit 230 includes a data communication circuit. The communication I/F unit 230 performs data communication with an external device connected via a communication line.

The storing unit 240 is a storage device such as a hard disk or a memory. The storing unit 240 stores processing information and a program 242 necessary for a variety of processing by the operation processing unit 250. The program 242 is loaded and executed by the operation processing unit 250 to realize various processing units. The program 242 is previously loaded from an external device or a recording medium via a data input/output function such as the communication I/F unit 230, and stored into the storing unit 240. Main information stored in the storing unit 240 includes, for example, management information 241.

The management information 241 includes NFT biometric information, attribute information, and so forth. For example, the management information 241 is generated or updated when a registration accepting unit 251 accepts registration of NFT biometric information and so forth. The management information 241 may be updated at any other timing in response to an instruction from the personal device 500, or the like. For example, when NFT biometric information, attribute information and so forth are transmitted to the user device 300 or the like in response to a usage request, part of the information included by the management information 241 may be acquired from the NFT market 400 or the like and updated.

FIG. 3 shows an example of information included by the management information 241. Referring to FIG. 3, the management information 241 includes, for example, NFT biometric information and attribute information. Here, the NFT biometric information can include identification information for identifying an NFT and biometric information. For example, the identification information is information for identifying an NFT, such as address on a blockchain of a corresponding NFT or ID (identification) of the NFT. Moreover, the biometric information includes, for example, at least one of a face feature value, a fingerprint feature value, an iris feature value, a vein feature value, and the like. The identification information and the biometric information included by the NFT biometric information may be other than those illustrated. Moreover, the attribute information includes a plurality of attributes. For example, the attributes include identification information such as a number privately or publicly assigned to an individual or a group to which the individual belongs, such as individual number, pension number, employee number, credit card number, and various kinds of membership card numbers. The attributes may be other than those illustrated.

FIG. 3 shows an example of the information included by the management information 241. The management information 241 may include part of the information illustrated in FIG. 3, and may include information other than those illustrated in FIG. 3. For example, FIG. 4 shows another example of the information included by the management information 241. Referring to FIG. 4, the management information 241 may include license information or the like, in addition to the NFT biometric information and the attribute information. Here, the license information is information indicating the scope of license for use of the NFT biometric information. For example, the license information may include information indicating the scope of license, such as licensee information indicating a licensee who is licensed to use the NFT biometric information, and purpose information indicating a purpose for which use of the NFT biometric information is licensed. The license information may include information indicating the scope of license other than those illustrated above. In addition, the management information 241 may include information other than those illustrated in this example embodiment, such as expiration information indicating the expiration date of the NFT biometric information or the license information, and specification information for specifying a person who has the NFT biometric information, such as address or age.

The operation processing unit 250 includes an arithmetic logic unit such as a CPU (Central Processing Unit) and a peripheral circuit thereof. The operation processing unit 250 loads the program 242 from the storing unit 240 and executes the program 242, thereby causing the abovementioned hardware and the program 242 to cooperate and realizing various processing units. Main processing units realized by the operation processing unit 250 include, for example, a registration accepting unit 251, a request accepting unit 252, a selecting unit 253, a data transmitting unit 254, and a fee managing unit 255.

The registration accepting unit 251 accepts registration of NFT biometric information and attribute information. For example, the registration accepting unit 251 accepts registration of NFT biometric information, attribute information and the like from the personal device 500 and the like via the communication I/F unit 230. Moreover, the registration accepting unit 251 stores the accepted NFT biometric information, attribute information and the like as the management information 241 into the storing unit 240.

The registration accepting unit 251 may receive other information such as license information, expiration information, and specification information from the personal device 500 and the like when or after accepting the registration. The registration accepting unit 251 can store the accepted various information as the management information 241 into the storing unit 240. Moreover, the registration accepting unit 251 may acquire part of the information included by the NFT biometric information, and the like, from the NFT market 400 and the like when accepting the registration, after accepting the registration, when receiving a usage request, or the like. In addition, the registration accepting unit 251 may be configured to notify acceptance of registration of the NFT biometric information to the NFT market 400 and the like when accepting registration from the personal device 500 and the like.

The request accepting unit 252 accepts a usage request that is a request for use of NFT biometric information and the like. For example, the request accepting unit 252 accepts a usage request from the user device 300 and the like via the communication I/F unit 230. A usage request accepted by the request accepting unit 252 may include information for specifying the sender of the usage request such as identification information previously determined for each user device 300, information showing the purpose of the NFT biometric information, information for specifying the scope requested to transmit, such as age and address, information showing the attributes requested to transmit. A usage request may include information other than those illustrated above.

The selecting unit 253 selects an attribute to transmit in response to a usage request among the attributes included by the attribute information. For example, when the request accepting unit 252 accepts a usage request, the selecting unit 253 selects an attribute to transmit in accordance with the accepted usage request. The selecting unit 253 may select an attribute at a timing other than that illustrated above, such as when the fee managing unit 255 to be described later accepts payment of a usage fee.

For example, the selecting unit 253 can select an attribute to transmit in accordance with the sender of the usage request. As an example, the selecting unit 253 accepts in advance registration of information showing an attribute to be used for each user device 300. The selecting unit 253 can select based on the information an attribute corresponding to the user device 300 that is the sender of the usage request. For example, the selecting unit 253 can be configured to, in a case where the sender of the usage request is an administrative organization, select an attribute previously determined in accordance with the sender, such as a pension number or an individual number.

Further, the selecting unit 253 may select an attribute by a method other than that illustrated above. For example, the selecting unit 253 may select an attribute based on information showing an attribute requested to transmit, received together with a usage request. Moreover, for example, the selecting unit 253 may select an attribute corresponding to the purpose based on information indicating the purpose. For example, an attribute for each purpose may be determined in advance or may be determined by any method. The selecting unit 253 may select an attribute by combining the methods illustrated above, such as narrowing down attributes to select in accordance with the sender and then specifying an attribute in accordance with the purpose. In addition, the selecting unit 253 may be configured to select only one attribute from among the attributes included by the attribute information, or may be configured to be able to select a plurality of attributes.

The data transmitting unit 254 transmits, in accordance with a usage request, NFT biometric information and an attribute selected by the selecting unit 253 to the sender of the usage request. In such a case that the usage request includes information for specifying the scope requested to transmit, the data transmitting unit 254 may be configured to transmit NFT biometric information and an attribute that are specified by the information.

The data transmitting unit 254 may be configured to transmit data on the condition that the fee managing unit 255 to be described later receives payment of a usage fee from the user device 300. In addition, in a case where the management information 241 includes license information, the data transmitting unit 254 may be configured to transmit, to the sender of a usage request, only NFT biometric information that data transmission to the sender of the usage request is previously licensed. Thus, the data transmitting unit 254 may be configured to transmit at least part of the managed NFT biometric information based on predetermined information.

Further, the data transmitting unit 254 may be configured to notify transmission of data (use of data) to the NFT market 400 after or before the transmission of the data. For example, the data transmitting unit 254 may give the abovementioned notification together with information for identifying NFT biometric information transmitted to the user device 300.

The fee managing unit 255 manages a fee for using the NFT biometric information.

For example, when the request accepting unit 252 receives a usage request, the fee managing unit 255 accepts payment of a usage fee from the sender of the usage request, such as the user device 300. The fee managing unit 255 may instruct the data transmitting unit 254 to transmit NFT transmission information in response to acceptance of a usage fee.

Further, when accepting a usage fee from the user device 300 or the like, the fee managing unit 255 can pay a usage fee for the NFT biometric information to the NFT market 400. At this time, the fee managing unit 255 may pay the amount after deducting any commission from the accepted usage fee, as a usage fee for the NFT biometric information to the NFT market 400. As will be described later, the NFT market 400 can pay a usage fee for the NFT biometric information to the personal device 500 in accordance with the payment from the fee managing unit 255. Therefore, it can also be said that the fee managing unit 255 pays a usage fee to the personal device 500 via the NFT market 400.

The user device 300 is an information processing device that transmits a usage request that is a request for use of the NFT biometric information to the information management apparatus 200. The user device 300 is, for example, a personal computer owned by any organization such as an administrative organization and a company. A function as the user device 300 may be realized, for example, on the cloud. The user device 300 may be owned by a user other than those illustrated above.

FIG. 5 shows an example of a characteristic configuration of the user device 300 in this example embodiment. With reference to FIG. 5, for example, the user device 300 includes a transmitting unit 310, a receiving unit 320, and a managing unit 330. For example, the user device 300 includes an arithmetic logic unit such as a CPU and a memory unit. The user device 300 can realize the abovementioned processing units by execution of a program stored in the memory unit by the arithmetic logic unit.

The transmitting unit 310 transmits a usage request to the information management apparatus 200, for example, in response to an operation by an operator who operates the user device 300. The transmitting unit 310 may transmit, together with the usage request, at least some of information for specifying the sender of the usage request, information indicating the purpose of the NFT biometric information, information for specifying the scope requested to transmit, such as age and address, information indicating an attribute requested to transmit, and so forth. The transmitting unit 310 may transmit information other than those illustrated above, together with the usage request.

Further, the transmitting unit 310 can pay a predetermined usage fee to the information management apparatus 200 when transmitting the usage request, or before or after the transmission. An existing mechanism for paying a fee may be used.

The receiving unit 320 receives the NFT biometric information and the attribute information from the information management apparatus 200. For example, the receiving unit 320 receives, from the information management apparatus 200, the NFT biometric information and the attribute information that the information processing apparatus 200 transmits in accordance with the usage request transmitted by the transmitting unit 310.

The managing unit 330 stores and manages the NFT biometric information and attribute information received by the receiving unit 320 in the memory unit. The managing unit 330 can manage the NFT biometric information and the attribute information so that an operator operating the user device 300 cannot check at least part of the NFT biometric information and attribute information stored in the memory unit. In other words, the managing unit 330 can make the received NFT biometric information, attribute information and so forth available on specified software or the like, while managing them as a black box so that they cannot be displayed or output to an external device.

The NFT market 400 has a blockchain and the like realized by a plurality of information processing devices and the like, and creates and trades NFTs on the blockchain. The NFT market 400 may be the same as an existing mechanism for dealing in NFTs.

For example, the NFT market 400 creates an NFT corresponding to biometric information in response to a request from the personal device 500. Moreover, the NFT market 400 manages notifications and the like from the information management apparatus 200, the personal device 500 and the like on the blockchain. The NFT market 400 may give a predetermined notification to the information management apparatus 200 and the personal device 500, such as a notification of use of biometric information to the personal device 500 when the NFT market 400 receives a notification of transmission of data from the information management apparatus 200.

Further, when accepting payment of a usage fee from the information management apparatus 200, the NFT market 400 can pay a predetermined usage fee to the corresponding personal device 500. At this time, the NFT market 400 may pay the amount after deducting any commission as the usage fee to the personal device 500.

The personal device 500 is an information processing device owned by a person who uses biometric information. For example, the personal device 500 may be an existing information processing device such as a personal computer, a tablet computer, or a smartphone.

For example, the personal device 500 can request the NFT market 400 to create an NFT corresponding to biometric information in response to an operation by an operator operating the personal device 500. The biometric information may be acquired by any means, for example, may be calculated by an external device or the personal device 500 based on image data acquired using an imaging device such as a camera included by the personal device 500. Moreover, the personal device 500 can request the information management apparatus 200 to register NFT biometric information and attribute information in response to an operation by an operator operating the personal device 500, or the like. In addition, the personal device 500 can receive payment of a usage fee from the NFT market 400 or the like, and can receive various notifications.

The above is an example of the configuration of the information management system 100. Subsequently, an example of the operation of the information management apparatus 200 will be described with reference to FIGS. 6 and 7.

First, an example of the operation of the information management apparatus 200 at the time of registration will be described with reference to FIG. 6. Referring to FIG. 6, the registration accepting unit 251 receives NFT biometric information, attribute information and the like from the personal device 500 and the like via the communication I/F unit 230 (step S101). The registration accepting unit 251 may acquire part of the NFT biometric information and the like from the NFT market 400 and the like in accordance with the reception from the personal device 500 and the like.

The registration accepting unit 251 may receive other information such as license information, expiration information, and specification information from the personal device 500 and the like when accepting the registration, after accepting the registration, and the like.

The registration accepting unit 251 associates the received information and stores as the management information 241 into the storing unit 240 (step S102). In addition, when accepting the registration from the personal device 500 and the like, the registration accepting unit 251 may notify acceptance of the registration of the NFT biometric information to the NFT market 400 and the like

The above is an example of the operation of the information management apparatus 200 at the time of registration. Subsequently, an example of the operation of the information management apparatus 200 at the time of use will be described with reference to FIG. 7.

Referring to FIG. 7, the request accepting unit 252 accepts a usage request that is a request for use of the NFT biometric information and the like from the user device 300 and the like (step S201).

The selecting unit 253 selects an attribute to transmit in accordance with the usage request from among attributes included by the attribute information (step S202). For example, the selecting unit 253 selects an attribute to transmit in accordance with the sender of the usage request. The selecting unit 253 may select an attribute by a method other than that illustrated above, for example, select an attribute in accordance with information received together with the usage request.

The fee managing unit 255 accepts payment of a usage fee from the sender of the usage request (step S203). In addition, the process of step S203 may be performed at a timing other than that illustrated in FIG. 7, for example, performed before step S202.

When the fee managing unit 255 accepts payment of the usage fee (Yes at step S203), the data transmitting unit 254 transmits the NFT biometric information and the attribute selected by the selecting unit 253 to the sender of the usage request (step S204). The data transmitting unit 254 may be configured to transmit only part of the managed information, for example, transmit only the NFT biometric information specified based on the information received together with the usage request.

The fee managing unit 255 pays a usage fee for the NFT biometric information to the NFT market 400 (step S205). At this time, the fee managing unit 255 may pay the amount after deducting any commission from the accepted usage fee, as the usage fee for the NFT biometric information to the NFT market 400. In addition, the process of step S205 may be performed at any timing after step S203.

The above is an example of the operation of the information management apparatus 200 at the time of use.

Thus, the information management apparatus 200 includes the request accepting unit 252 and the data transmitting unit 254. According to such a configuration, in accordance with a usage request accepted by the request accepting unit 252, the data transmitting unit 254 can transmit at least part of the NFT biometric information and the attribute information managed by the apparatus to the sender of the usage request. Consequently, it is possible acquire necessary NFT biometric information and attribute as needed, and it is possible to reduce time and effort for utilizing biometric information.

Further, the information management apparatus 200 includes the selecting unit 253. According to such a configuration, the data transmitting unit 254 can transmit an attribute selected by the selecting unit 253 together with the NFT biometric information. Consequently, it is possible to transmit only an appropriate attribute for the sender of the usage request or the like, to the sender of the usage request, and it is possible to reduce time and effort for utilizing biometric information more appropriately.

Further, the information management apparatus 200 includes the fee managing unit 255. According to such a configuration, the fee managing unit 255 can pay a usage fee to the personal device 500 via the NFT market 400. As a result, it is possible to pay an appropriate usage fee to the personal device 500, for example, when utilizing biometric information. Moreover, in the case described in this example embodiment, a usage fee is paid to the personal device 500 via the NFT market 400, so that the information management apparatus 200 does not need to have a configuration for paying a usage fee to the personal device 500 directly.

In this example embodiment, the information management apparatus 200 stores, as biometric information, a feature value calculated based on image data and the like. That is to say, a case in which an NFT corresponds to biometric information such as a feature value has been illustrated. However, the information management apparatus 200 may acquire, instead of or together with the feature value, image data such as a face image or a fingerprint image from the personal device 500 or the like and store them. That is to say, as the NFT biometric information, an NFT and biometric information such as image data may be associated with each other.

FIG. 8 is an example of the configuration of the information management apparatus 200 in the case of storing image data. Referring to FIG. 8, the storing unit 240 stores image management information 243 instead of the management information 241.

The image management information 243 can include at least part of the NFT biometric information and the attribute information in the same manner as the management information 241 illustrated in FIG. 3. Moreover, the image management information 243 includes, as biometric information, image data such as a face image together with or instead of a feature value.

Further, referring to FIG. 8, by loading the program 242 from the storing unit 240 and executing the program 242, the operation processing unit 250 can realize a calculating unit 256 in addition to the registration accepting unit 251, the request accepting unit 252, the selecting unit 253, the data transmitting unit 254, the fee managing unit 255 and so forth.

The calculating unit 256 calculates a feature value based on the image data. The calculating unit 256 can calculate a feature value by a known means, for example, extract feature points such as eyes and nose from face image data and calculate a feature value based on the extracted feature points. For example, in response to acceptance of a usage request by the request accepting unit 252, the calculating unit 256 can calculate a feature value by a method corresponding to the sender of the usage request.

Thus, the information management apparatus 200 can include the calculating unit 256. According to such a configuration, the data transmitting unit 254 can transmit NFT biometric information including a feature value calculated by a method corresponding to the sender of a usage request to the sender of the usage request. Consequently, for example, the biometric information can be securely used at the sender of the usage request, and a risk that the transmitted biometric information cannot be used by the sender of the usage request due to a difference in the feature value calculation method can be reduced. In addition, the information management apparatus 200 may be configured to transmit image data or the like as it is. In this case, the user device 300 or the like may have a function as the calculating unit 256.

Further, in this example embodiment, a case where the information management system 100 has the information management apparatus 200 and the NFT market 400 separately has been illustrated. However, in the information management system 100, the information management apparatus 200 and the NFT market 400 may be configured integrally as illustrated in FIG. 9. Even if the information management apparatus 200 and the NFT market 400 are thus configured integrally, the object of the present invention can be achieved in the same manner as described above.

The present invention can be utilized, for example, for providing various services using biometric information, such as when an administrative organization such as a local government uses biometric information such as face recognition to control boarding on a bus and other means of transportation. The present invention may also be utilized, for example, for providing a service related to the metaverse (virtual world), such as when a company or the like holds a digital concert. For example, in a case where the present invention is applied to providing a service related to the metaverse or the like, it is possible to prove without fail that a person actually exists in the virtual world. In other words, when a provider of a metaverse-related service utilizes the present invention when providing a service by having a function as the user device 300, it is possible to appropriately prevent impersonation in the virtual world.

### Second Example Embodiment

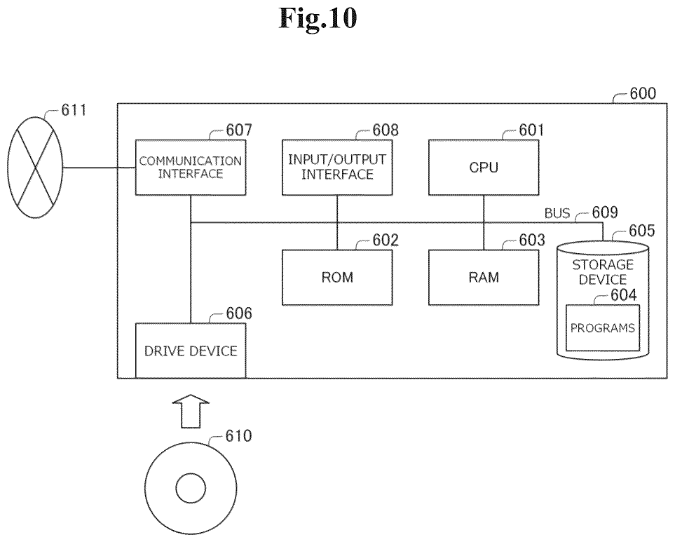

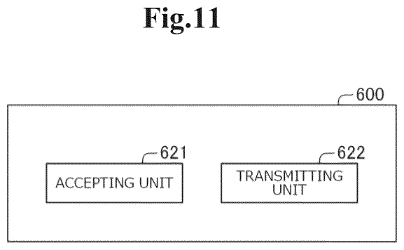

Next, a second example embodiment of the present disclosure will be described with reference to FIGS. 10 and 11. In the second example embodiment of the present disclosure, the overview of the configuration of an information management apparatus 600 that is an information processing apparatus will be described.

FIG. 10 shows an example of the hardware configuration of the information management apparatus 600. Referring to FIG. 10, the information management apparatus 600 has, as an example, the following hardware configuration including;
a CPU (Central Processing Unit) 601 (arithmetic logic unit),
a ROM (Read Only Memory) 602 (memory unit),
a RAM (Random Access Memory) 603 (memory unit),
programs 604 loaded to the RAM 603,
a storage device 605 that stores the programs 604,
a drive device 606 that performs reading from and writing into a recording medium 610 outside the information processing apparatus,
a communication interface 607 connected to a communication network 611 outside the information processing apparatus,
an input/output interface 608 that performs input/output of data, and
a bus 609 that connects the respective components.

Further, by acquisition and execution of the programs 604 by the CPU 601, the information processing apparatus 600 can realize functions as an accepting unit 621 and a transmitting unit 622 shown in FIG. 11. For example, the programs 604 are stored in the storage device 605 or the ROM 602 in advance, and loaded to the RAM 603 or the like and executed by the CPU 601 as necessary. Moreover, the programs 604 may be provided to the CPU 601 via the communication network 611, or may be stored in the recording medium 610 in advance and read out and provided by the drive device 606 to the CPU 601.

FIG. 11 shows an example of the hardware configuration of the information management apparatus 600. The hardware configuration of the information management apparatus 600 is not limited to the abovementioned case. For example, the information management apparatus 600 may include part of the above configuration, such as without the drive device 606.

The accepting unit 621 accepts, from an external device, a usage request that is a request for use of NFT biometric information that associates biometric information corresponding to the characteristics of a person with a non-fungible token. As an example, the information management apparatus 600 stores NFT biometric information that associates biometric information with a non-fungible token in the storage device of the information management apparatus 600. For example, the accepting unit 621 accepts, from an external device, a usage request that is a request for use of NFT biometric information stored in the information management apparatus 600.

The transmitting unit 622 transmits, based on the usage request accepted by the accepting unit 621, NFT biometric information and an attribute owned by a person to the sender of the usage request. For example, an attribute is associated with NFT biometric information and managed in the storage device or the like of the information management apparatus 600.

Thus, the information management apparatus 600 includes the accepting unit 621 and the transmitting unit 622. According to such a configuration, the transmitting unit 622 can transmit, based on a usage request accepted by the accepting unit 621, NFT biometric information and an attribute to the sender of the usage request. As a result, it is possible to transmit necessary information in response to a usage request, and it is possible to reduce time and effort to utilize biometric information.

An information processing apparatus such as the abovementioned information management apparatus 600 can be realized by installation of a predetermined program in the information processing apparatus. Specifically, a program as another aspect of the present invention is a program for causing an information processing apparatus to realize processes to: accept, from an external device, a usage request that is a request for use of NFT (non-fungible token) biometric information that associates biometric information corresponding to the characteristic of a person with a non-fungible token; and transmit, based on the accepted usage request, the NFT biometric information and an attribute owned by the person that is associated with the NFT biometric information and managed to a sender of the usage request.

Further, an information management method executed by the abovementioned information processing apparatus includes: accepting, from an external device, a usage request that is a request for use of NFT (non-fungible token) biometric information that associates biometric information corresponding to the characteristic of a person with a non-fungible token; and transmitting, based on the accepted usage request, the NFT biometric information and an attribute owned by the person that is associated with the NFT biometric information and managed to a sender of the usage request.

Since inventions of a program (or a recording medium), an information management method and so forth with the above configurations have the same actions and effects as in the described case, it is possible to achieve the object of the present invention.

### <Supplementary Notes>

The whole or part of the example embodiments disclosed above can be described as the following supplementary notes. Below, the overview of an information management apparatus and so forth according to the present invention will be described. However, the present invention is not limited to the following configurations.

### (Supplementary Note 1)

An information management apparatus comprising:
an accepting unit that accepts a usage request from an external device, the usage request being a request for use of NFT (non-fungible token) biometric information associating biometric information corresponding to a characteristic of a person with a non-fungible token; and
a transmitting unit that transmits the NFT biometric information and an attribute of the person to a sender of the usage request accepted by the accepting unit based on the usage request, the attribute being managed in association with the NFT biometric information.

### (Supplementary Note 2)

The information management apparatus according to Supplementary Note 1, comprising
a selecting unit that selects the attribute to transmit from attribute information including a plurality of attributes based on the usage request, wherein
the transmitting unit transmits the NFT biometric information and the attribute selected by the selecting unit.

### (Supplementary Note 3)

The information management apparatus according to Supplementary Note 2, wherein
the selecting unit selects the attribute according to the sender of the usage request.

### (Supplementary Note 4)

The information management apparatus according to Supplementary Note 2 or 3, wherein:
the accepting unit accepts information showing a purpose of the NFT biometric information together with the usage request; and
the selecting unit selects the attribute according to the purpose of the NFT biometric information.

### (Supplementary Note 5)

The information management apparatus according to any one of Supplementary Notes 1 to 4, comprising
a fee managing unit that accepts payment of a usage fee for the NFT biometric information from the sender of the usage request, wherein
the fee managing unit pays a fee corresponding to the usage fee to an NFT market that creates the non-fungible token, thereby performing payment of the fee to a personal device having registered the biometric information via the NFT market.

### (Supplementary Note 6)

The information management apparatus according to any one of Supplementary Notes 1 to 5, wherein
the biometric information is a feature value corresponding to a physical characteristic of the person calculated based on image data.

### (Supplementary Note 7)

The information management apparatus according to any one of Supplementary Notes 1 to 6, wherein
the biometric information is image data corresponding to a physical characteristic of the person, the information management apparatus comprising
a calculating unit that calculates a feature value based on the image data, wherein
the transmitting unit transmits the NFT biometric information including the feature value calculated by the calculating unit.

### (Supplementary Note 8)

The information management apparatus according to any one of Supplementary Notes 1 to 7, wherein
the attribute includes a number privately or publicly assigned to the person or a group to which the person belongs.

### (Supplementary Note 9)

An information management method by an information processing apparatus, the information management method comprising:
accepting a usage request from an external device, the usage request being a request for use of NFT (non-fungible token) biometric information associating biometric information corresponding to a characteristic of a person with a non-fungible token; and
transmitting the NFT biometric information and an attribute of the person to a sender of the accepted usage request based on the usage request, the attribute being managed in association with the NFT biometric information.

### (Supplementary Note 10)

A computer program for causing an information processing apparatus to realize processes to:
accept a usage request from an external device, the usage request being a request for use of NFT (non-fungible token) biometric information associating biometric information corresponding to a characteristic of a person with a non-fungible token; and
transmit the NFT biometric information and an attribute of the person to a sender of the accepted usage request based on the usage request, the attribute being managed in association with the NFT biometric information.

The program described in the above example embodiments and supplementary notes is stored in a storage device, or recorded on a computer-readable recording medium. For example, the recording medium is a portable medium such as a flexible disk, an optical disk, a magneto-optical disk, and a semiconductor memory.

Although the present invention has been described above with reference to the example embodiments, the present invention is not limited to the above example embodiments. The configurations and details of the present invention can be changed in various manners that can be understood by one skilled in the art within the scope of the present invention.

The present invention is based upon and claims the benefit of priority from Japanese patent application No. 2022-021793, filed on Feb. 16, 2022, the disclosure of which is incorporated herein in its entirety by reference.

### REFERENCE SIGNS LIST

100 information management system
200 information management apparatus
210 operation input unit
220 screen display unit
230 communication I/F unit
240 storing unit
241 management information
242 program
243 image management information
250 operation processing unit
251 registration accepting unit
252 request accepting unit
253 selecting unit
254 data transmitting unit
255 fee managing unit
256 calculating unit
300 user device
310 transmitting unit
320 receiving unit
330 managing unit
400 NFT market
500 personal device
600 information management apparatus
601 CPU
602 ROM
603 RAM
604 programs
605 storage device
606 drive device
607 communication interface
608 input/output interface
609 bus
610 recording medium
611 communication network
621 accepting unit
622 transmitting unit

What is claimed is:

1. An information management apparatus comprising:
at least one memory configured to store instructions; and
at least one processor configured to execute the instructions to:
accept a usage request from an external device, the usage request being a request for use of NFT (non-fungible token) biometric information associating biometric information corresponding to a characteristic of a person with a non-fungible token; and
transmit the NFT biometric information and an attribute of the person to a sender of the accepted usage request based on the usage request, the attribute being managed in association with the NFT biometric information.

2. The information management apparatus according to claim 1, wherein the at least one processor is configured to execute the instructions to:
select the attribute to transmit from attribute information including a plurality of attributes based on the usage request; and
transmit the NFT biometric information and the selected attribute.

3. The information management apparatus according to claim 2, wherein the at least one processor is configured to execute the instructions to
select the attribute according to the sender of the usage request.

4. The information management apparatus according to claim 2, wherein the at least one processor is configured to execute the instructions to:
accept information showing a purpose of the NFT biometric information together with the usage request; and
select the attribute according to the purpose of the NFT biometric information.

5. The information management apparatus according to claim 1, wherein the at least one processor is configured to execute the instructions to:
accept payment of a usage fee for the NFT biometric information from the sender of the usage request; and
pay a fee corresponding to the usage fee to an NFT market that creates the non-fungible token, thereby performing payment of the fee to a personal device having registered the biometric information via the NFT market.

6. The information management apparatus according to claim 1, wherein
the biometric information is a feature value corresponding to a physical characteristic of the person calculated based on image data.

7. The information management apparatus according to claim 1, wherein;
the biometric information is image data corresponding to a physical characteristic of the person; and
the at least one processor is configured to execute the instructions to:
calculate a feature value based on the image data; and
transmit the NFT biometric information including the calculated feature value.

8. The information management apparatus according to claim 1, wherein
the attribute includes a number privately or publicly assigned to the person or a group to which the person belongs.

9. An information management method by an information processing apparatus, the information management method comprising:
accepting a usage request from an external device, the usage request being a request for use of NFT (non-fungible token) biometric information associating biometric information corresponding to a characteristic of a person with a non-fungible token; and
transmitting the NFT biometric information and an attribute of the person to a sender of the accepted usage request based on the usage request, the attribute being managed in association with the NFT biometric information.

10. A non-transitory computer-readable recording medium with a program recorded, the program comprising instructions for causing an information processing apparatus to realize processes to:
accept a usage request from an external device, the usage request being a request for use of NFT (non-fungible token) biometric information associating biometric information corresponding to a characteristic of a person with a non-fungible token; and
transmit the NFT biometric information and an attribute of the person to a sender of the accepted usage request based on the usage request, the attribute being managed in association with the NFT biometric information.
